(19) United States
(12) Patent Application Publication
(10) Pub. No.: US 2014/0263843 A1
(43) Pub. Date: Sep. 18, 2014

(54) Universal Spacecraft Architecture

(71) Applicant: The Board of Trustees of the Leland Stanford Junior University, Palo Alto, CA (US)

(72) Inventors: Mark A. Cappelli, Stanford, CA (US); Nicolas Claude Gascon, Menlo Park, CA (US)

(73) Assignee: The Board of Trustees of the Leland Stanford Junior University, Palo Alto, CA (US)

(21) Appl. No.: 14/197,261

(22) Filed: Mar. 5, 2014

Related U.S. Application Data
(60) Provisional application No. 61/777,215, filed on Mar. 12, 2013.

(51) Int. Cl. B64G 1/66; G06F 17/28

(52) U.S. Cl. CPC B64G 1/66; G06F 17/289
USPC 244/159.4; 704/2; 29/428

(57) ABSTRACT

A system and method for assembling a spacecraft in orbit using orbiting modules. Each module has a function such as fuel, transport, communication and payload. A command and control system and logic assembles the modules for missions. After use the modules may be disassembled and parked in orbit. The assembly of modules for a mission is controlled by a logic that assesses the mission requirement, module status and capability and matches resources. The referenced command and control system and logic is used to maneuver vehicles and modules and controls missions. Communications between and among modules and signal sources are facilitated by a language protocol that has a library of commands and responses accessible by signals using divergent communications languages. The protocol also converts common programming language to a language compatible for use by a recipient module, logic or communication satellite or ground station.

### RELATED APPLICATION

This application claims priority to and the benefit of the filing date of provisional application, U.S. Ser. No. 61/777,215, filed on Mar. 12, 2013.

### COPYRIGHT NOTICE

© Mar. 3, 2014 The Trustees of Leland Stanford University, Mark Cappelli, PhD and Nicolas Gascon. This patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d), (e).

### TECHNICAL FIELD

The technical field is the system, method and apparatus for launching spacecraft and spacecraft modules into orbit and configuring the orbiting modules as needed into various vehicle configurations. The modules have multiple capabilities necessary for a spacecraft. These are, among others, payload, propulsion, fuel, refinery, resource processing, communications and schema management and optimization.

### BACKGROUND

Monolithic rockets launch payloads into orbit carrying all of the functions for the mission. The monolithic vehicle has launch and maintenance costs associated with a combined vehicle and payload. Payloads in orbit have a limited useful life and expire. The launch components either reenter the atmosphere and burn or orbit as space junk. There is a need for a more efficient spacecraft system to reduce costs with reusable components. Likewise there is a need to have fuel available in orbit to refuel spacecraft modules. Propellant refined in orbit and supplied to modules as needed lowers costs and increases the flexibility of payloads. Likewise, there is a need to provide communications to connect the space vehicles and components to allow the management of a flexible space vehicle schema. And an optimization schema is needed to manage components and assembly of components into space vehicles and the resources for the components and vehicles.

Additional aspects and advantages of this device will be apparent from the following detailed description of examples, which proceeds with reference to the accompanying drawings.

### BRIEF DESCRIPTION OF THE DRAWINGS

FIG. 1 is a schematic of a modular spacecraft system.

FIG. 2 is a representation of a spacecraft assembled from modules.

FIG. 3 is a diagram of a resource processing facility.

FIG. 4 is a diagram of a schema for processing and transport of resources.

FIG. 5 is a representative communication network for the modules.

FIG. 5A is a representation of alternative communications network configurations.

FIG. 6 is a module assembly schema.

FIG. 7 is a schema for processing information received by an agent for space module communication, optimization and control.

FIG. 8 is representation of the components and trajectories of a star-type communications satellite constellation in low earth orbit.

FIG. 9 is a representation of a ground and space communications network for a scientific mission and the organization of space components from stand-by to active configuration.

FIG. 10 is a diagram of the logic for processing data and requests received by a space module.

FIG. 11 is a schematic representation of a communication and functional language for managing modules in orbit.

### DETAILED DESCRIPTION

The term space as used in this specification means the region lying beyond an altitude of 100 km above the Earth's mean sea level (MSL). The terms spacecraft, satellite and space vehicle may be used interchangeably and generally refer to any orbiting satellite, interplanetary vehicle or spacecraft system. The term element and module may be used interchangeably and generally refers to components of a spacecraft, satellite or space vehicle. When an element is referred to as being connected, mated or coupled to another element, it can be directly connected or coupled to another element, or intervening elements may be present. Furthermore, connected, mated or coupled may include wirelessly connected, mated or coupled. Likewise the term first and second used to describe various elements does not limit the elements. It is a way to distinguish one from another.

A space schema based on modules allows assembly and reassembly of spacecraft components in space into vehicles. The vehicles provide transportation, consumables, power and propulsion for payloads in support of automated and manned space missions. The vehicles are assembled from modules serving specific functions. For illustration, some of the functions are propellant storage, energy storage, orbit transfer, station keeping, communications, command and control, habitat, and additional functions as needed. The vehicle consists of several modules that each accomplishes specialized tasks.

A payload module contains the resources to be transported by the vehicle. Example are raw materials as inputs for the resource processing facility, refined materials produced by the facility, manufactured hardware, scientific instruments, power plants, habitats, entire vehicles or entire facilities.

A consumables module contains propellants or energy sources such as hydrogen and oxygen, raw materials, or nutrients for living beings.

An electrical power module typically has solar arrays, batteries and a power-processing unit for providing electricity to the other modules. The function of this unit includes power regulation, power routing and switching, voltage regulation, and AC/DC conversion and like electrical systems management functions.

An environmental control module monitors and regulates the vital parameters of the modules within the vehicles, such as temperature, pressure, atmosphere and radiation.

A locomotion and orientation module typically consists of a set of rocket thrusters and their associated propellant tanks and regulation systems for moving the entire vehicle between locations, and for station keeping, drift correction, and rotating the vehicle to a specified direction.

A monitoring, command and communications module manages the flow of information and commands within the vehicle, and between the vehicle and the outside.

The modules are connected through various types of interfaces. Compatible mechanical, communications, and command interfaces allow interchangeability. Interface examples are, mechanical joints, mating mechanisms, consumable transfer valves, electrical connectors and data transfer connector. The vehicle also has various types of interfaces for connection and transfer of resources and data with resources processing facilities and other vehicles. Docking mechanisms, flow pipes and valves facilitate resource transfer. Communications interfaces may be either physical or transmissions in all wavelengths based on data formats, protocols including analog signals. All radiation spectrums may be used for communications.

Modules and elements have different functions and life spans. For example, structural elements have low wear rates and can be used for decades, if not longer. Modules and replaceable elements allow for replacement of old technology and failed components. Uniform interfaces facilitate upgrades and replacement of elements and modules.

A space schema described in this document has a resource processing facility and one or more vehicles, all primarily operating out of the Earth's atmosphere, that is, on or near a celestial body a planet, an asteroid, or other type of celestial body, in near Earth orbit, or in deep space.

As previously described, The vehicles provide transportation, consumables, electric power, propulsion, and other services to payloads in support of a variety of space missions, automated or manned. The vehicles may also transport resources to the facilities and may deliver processed resources to other vehicles. In general, the vehicles comprise several modules each serving a specific function that can be assembled into a single vehicle. An assembled vehicle may include any of these specific functions; propellant storage, energy storage, orbit transfer, station keeping, communications, command and control, habitat and other functions.

A refinery processes resources collected on site or from other locations for use as propellant, energy carriers, structural components, manufactured hardware, life support consumables, and other uses. Facilities may have power plants, resources processing devices, environmental control and process control modules, receiving and delivery interfaces, and may be monitored and controlled on site or remotely. The facilities may be manned or unmanned. Variations of the facilities also have storage modules for resources and end products, and have maneuvering modules for controlling or changing the location of the entire facility. The facilities may come in various configurations: refinery, recycling center, factory, farm, or other configurations.

Components can be engineered for the space environment as required. An example is that all components need not be hardened for radiation. Environmental conditioning is dependent on a module's system requirements and may vary among modules.

Launching modules instead of an entire vehicle allows the use of various launch vehicles with load specific risk considerations. For example, low value payload merits lower reliability launch vehicle and protocol and less expense. For example, propellant or materials for manufacturing may be launched separately thereby minimizing risk to an expensive payload.

Shown in FIG. 1, is a schema 100 for a spacecraft assembled from orbiting modules and moving modules and spacecraft in orbit and between orbits and interplanetary trajectories. A payload 102 is launched into orbit, typically a low earth orbit (LEO). The payload may be any one of multiple packages such as experiments, surveillance equipment, fuel, raw materials, life support resources, humans, etc. Once in LEO a service vehicle module 104 provides transportation, consumables, electric power, propulsion and other services to payloads in support of a variety of space missions. Service vehicle module 104 mates with the payload module 102 to transport it to another orbit or position the payload module 102 within an orbit. The service vehicle module 104 may provide supplies to the payload module 102 as needed. The service vehicle module 104 moves and mates modules in and between orbits. The combined service vehicle 104 and payload 102 modules are propelled into High Earth Orbit (HEO). Examples of a HEO include a geosynchronous orbit, or a highly elliptic orbit such as the Molniya orbit. Modules 102 and 104 rendezvous with a propulsion service module 106 in HEO. The three-mated modules, 102, 104 and 106 function as a spacecraft. A refinery module 108 is in LEO and accepts raw materials for processing into fuel and other materials to replenish the various modules.

A space schema 100 includes one or more vehicles and resource processing facilities. The vehicles comprise at least one service vehicle module 104 and one payload module 102, which may be mated using a standard interface and may be separated during the mission. The payload module 102 contains the resources to be moved by the service vehicle module 104. For example, the payload module 102 may consist of scientific instruments, telecommunication antennas and transponders, consumables storage such as fuel tanks, human habitats, or combinations thereof. The service vehicle module 104 can consist of a locomotion subsystem for example, a set of rocket thrusters with the associated electric power, propellant storage, delivery and regulation equipment. If demanded, a second service vehicle module 104 can mate the propulsion service module 106 to the payload module 102 to provide locomotion. This second service vehicle module 104 can also serve to fuel or refuel the mated spacecraft with propellant that it obtains by accessing a resources processing facility 108. In the resources processing facility 108, raw materials are received at an interface such as a fluid fill/drain valve and may be stored for later use. The resources processing facility 108 consists of at least one resources processing device, one resources delivery interface, one environmental control device and one process control device.

Another propellant module 106 is shown in orbit as a fuel resource. A service vehicle module 104 may mate with it and move it into LEO for refueling by the refinery module 108. There may be multiple propellant modules 106 parked in orbit as a fuel resource. The resource processing facility 108, referred to as a refinery 108 in this example, may turn raw materials into refined materials for other uses. For example, water collected on Earth or from other sources in space, e.g. from a comet, may be stored in liquid form and delivered to the refinery 108 via the service vehicles 104. The water may be transferred to the storage tanks of the refinery 108 using a system of pipes and flow regulators pressured by water vapor. The refinery 108 may be electrically powered by a system of solar arrays, energy storage, e.g., batteries and power regulation units. The liquid water available in the refinery 108 may be dissociated into gaseous oxygen (O2) and gaseous hydrogen (H2) using electrolysis. The gas products may be stored, for example, in either gaseous or liquid phase in high-pressure tanks for later use.

In a resource processing facility 300 later shown in FIG. 3, referred to as a factory, raw materials may be turned into manufactured hardware or food and other consumables such as liquid nutrients or oxygen for living beings. A recycling center converts manufactured hardware, typically at the end of its' life cycle into energy and manufactured items.

Still referring to FIG. 1, an Earth communication system 110 is in communication with an orbiting spacecraft 112 that has the capability to route communications among modules and vehicles. A communications schema is represented by a cloud concept 114 that uses communications elements in modules and vehicles to form a communications network. The communications cloud 114 is capable of communicating with all components in the communications schema.

Referring to FIG. 2, a representative vehicle 200 is comprised of modules that accomplish specialized tasks. A payload module 202 contains the resources to be transported by the vehicle 200. The resources may be raw materials to be used as inputs for the resource processing facility, refined materials produced by the facility, manufactured hardware, scientific instruments, power plants, habitats, entire vehicles or entire facilities. The consumables module 204 may contain propellants or energy sources such as hydrogen and oxygen, or nutrients for living beings. The electrical power module 206 comprises solar arrays, batteries and a power-processing unit for providing electricity to the other modules. The environmental control module 208 monitors and regulates the vital parameters of the modules within the vehicles, such as temperature, pressure. The locomotion and orientation module 210 contains a set of rocket thrusters and their associated propellant tanks and regulation systems, for moving the entire vehicle 200 between locations, for station keeping (drift correction), and for rotating the vehicle to a specified direction. The monitoring, command and communications module 212 manages the flow of information and commands within the vehicle, and between the vehicle and the outside. The modules are connected and mated through various types of interfaces 216. There are interfaces 216 for mechanical joints, mating interfaces, flow pipes and valves for transferring consumables, electrical connectors and data transfer. The vehicle 200 also has various types of interfaces for connection and transfer of resources and data with resources processing facilities and other vehicles. For examples, docking mechanisms, flow pipes and valves, or transmission/reception antennas.

Referring to FIG. 3, the resources processing facility 300 consists of several modules that can each accomplish specialized tasks. Liquid water is a resource 302 to be processed. It is transferred through a fill/drain valve receiving interface 304 to the storage tanks 306 of the refinery via a system of pipes and flow regulators and pressured by a system of pumps. The liquid water available in the refinery is dissociated into gaseous oxygen (O2) and gaseous hydrogen (H2) using electrolysis in a processing module 308. The gas products are stored in high-pressure tanks 310 for later transfer through a delivery interface 312 that may be a fill/drain valve using pipes, flow regulators and pressurization devices.

Electricity for the electrolysis comes from a power plant 316 consisting of solar arrays, batteries and power regulation units. Electricity also powers other units within the refinery 108. A process control unit 318 can start or stop the electrolysis, regulate the reaction rate, water input flow and gas output flow. An environmental control unit 320 regulates the temperature of the facility components. A communications unit 322 sends the refinery's parameters such as water and gases quantities, electric power consumption, line pressures, temperatures to a remote station or receives commands for the refinery 108. A maneuvering module 324 consisting of rocket thrusters and their associated propellant tanks and regulation systems are attached to the refinery 108 for station keeping.

In the processing facility 300, resources 314 are processed from raw materials or manufactured items that are susceptible to recovery procedures. Metal is one such material as is fluid and carbon based biologic materials.

Referring to FIG. 4, a resource module 302 is sent and mated to a service vehicle module 104 as described previously. The resources can be produced on Earth, or extracted from a space body, e.g. an asteroid, Earth's moon or a comet, and sent to the service vehicle module 104 with a rocket launch vehicle. The service vehicle module 104 and the resources module 302 are mated and the entire assembly goes to the location of a resource processing facility 300 such as described previously, for example, a water electrolysis plant in LEO. The resources are transferred to the processing facility 300, transformed into processed resources 306 such as gaseous hydrogen and oxygen and stored in a processed resources module 106. The processed resources module 106 is mated to another service vehicle module 104 for transport to another location for refueling another vehicle.

Referring to FIG. 5, shown is an exemplary communications schema 500 with a ground base communication facility 502, a resource processing facility 504, a space communications facility 506 and a resource transport vehicle 508. Each have communication elements capable of sending, receiving, and relaying information with other components of the infrastructure using electromagnetic transmission, radio frequencies (RF), laser beam transmission or any communication signal. The information transmitted via the communications elements can include data relative to the internal status of the spacecraft. Example of data are; propellant remaining on-board, spacecraft environment data, temperature, situational data, orbital elements of the spacecraft, messages for human beings, voice and picture messages, sequences of commands for remote control, software updates and other type of information. The communications can be routine or one time, scheduled or unscheduled. The information can come from elements within a space vehicle such as an optimization element, a space-based resource processing facility or from a ground based communication facility. Communications within the network can be relayed by space based communication facilities 112 and 506 or ground facilities 110 and 502. The communications network 114 can be organized around a central hub referred to as a star topology 510 as shown in FIG. 5A, or distributed between the infrastructure components in various configurations such as a mesh topology 512.

Still referring to FIG. 5, the communications elements comprise an input and output transmission subsystem, for example, an RF antenna or a laser diode, a signal processing subsystem for performing functions such as noise filtering, signal amplification, multiplexing, DE multiplexing and other functions, and support subsystems such as power supplies, thermal control, monitoring, and other support subsystems.

Referring to FIG. 6, a space schema 600 in Earth orbit provides telecommunications and remote sensing services to ground and space stations. The elements of the space schema are launched from the ground to a LEO at an altitude of a few hundred kilometers. A resource processing facility 300 that in some instance is a fuel refinery 108 carries containers 604 that store unrefined resources. Water is one of the preferred resources to be stored in containers 604 because of its low launch costs and risks, and its many applications, such as propellant, energy carrier or as a basic supply for manned missions. Water mined from Earth's moon or other terrestrial bodies may be resources used in the refinery. The processed resources such as gaseous hydrogen and oxygen are stored in fuel containers 606 that can stay attached/mated to the processing facility 300 or be detached/unmated for transport to another location. An orbit transfer module 608 can be mated to other modules of the infrastructure for transporting them to another orbit. The orbit transfer module 608 can use high thrust rockets such as chemical rockets for rapid transfers, or high specific impulse rockets such as electromagnetic rockets for mass efficient transfers.

In one vehicle assembly configuration 610, an orbit transfer module 608 is mated to a service module 104. After transfer to the geostationary orbit, the service vehicle module 104 and the orbit transfer module 608 are unmated. The orbit transfer module 608 is moved back to LEO and the service vehicle module 104 remains in HEO using high specific impulse rockets.

In another vehicle assembly configuration 612 an orbit transfer module 608 is mated to a payload module 102 that may consist of telecommunications antennas, transponders and support equipment. After transfer to HEO, the orbit transfer 608 and the payload 102 modules are unmated. The payload module 102 is mated to a service vehicle module 104. In this satellite assembly configuration 614, the service vehicle module 104 provides electric power to the payload module 102 and uses high specific impulse (i.e. mass efficient) rockets for keeping the entire assembly 614 on station.

In another vehicle assembly configuration 616 an orbit transfer module 608 is mated to a processed propellant container 606. Once in HEO, the vehicle assembly 616 ferries the propellant container 606 between HEO slots for refueling service vehicle modules 104 that are standing alone or are part of a satellite assembly 614. Once the processed propellant container 606 is depleted, the entire assembly 616 is moved back to LEO, the container 606 and the orbit transfer vehicle 608 are unmated, and the container 606 is mated to the resource processing facility 300 for replenishing.

In another vehicle assembly configuration, an orbit transfer module 608 is mated to a combination of service vehicle modules 104, payload modules 102 and processed propellant containers 606 for transfer to HEO.

The orbit transfer module 608 can accomplish other missions such as the relocation of satellite assemblies in HEO to other orbital slots or move inoperative or obsolete modules/assemblies to a repair/disposal space-based facility not shown.

The space infrastructure described in previous sections is managed by a dedicated management system. The function of the system is to optimize the use of the various modules of the infrastructure for fulfilling its mission and for best performance. For example, in a telecommunication constellation 114, the system can monitor the flow of data through the constellation and respond to an increased flow to or from a ground area, e.g. a city by allocating more transponder capacity to that area. The constellation's structure 114 is flexible as described in previous sections, e.g. the orbital elements altitudes, inclination angles, etc. and the various hardware modules of the constellation can be reorganized to satisfy the operator's needs. In order to respond to changes in data flow, the constellation management system can then use various optimization tools to choose between many options: modify transponder allocation times, move communications payloads to different orbits, etc. Example optimization tools are: evolutionary strategies, genetic algorithms, Monte Carlo simulation approach, and multi-state/multi-objective strategies. The constellation management system comprises data and logic that can be stored in various pieces of hardware such as hard drives or flash memories in one or more modules and can be modified by command or automatically by another software system.

An agent is defined as a spacecraft module, or a set of spacecraft modules, that is capable of receiving external or internal information, processing it and acting upon it. Information may be broadly classified as data and requests. When a data is received, the agent can be either passive or active, whereas when a request is received, the agent is expected to act upon it if possible and according to the rules of operation for this agent.

Shown in FIG. 7, is a schema for processing information 701 received by an agent for space module communication, optimization and control. During the process, the agent may interact with the management system 702, which may be stored entirely within the agent, entirely outside the agent or partly inside and partly outside. The management system is composed of a database module 703 that receives, stores and delivers information, e.g. measurements from sensors, user-defined mission rules, orbital parameters and rules and logic module 704, that can help in evaluating and optimizing the various options for responding to requests. The interaction between the agent and the database 703 may be receptive or active. In a receptive mode the agent retrieves information from the database. In the active mode the agent modifies the database. Both receptive and active modes may operate concurrently.

A reception module 705 that may be an optical, radar, thermal or mechanical sensor, or a communication antenna first receives the information 701. The output signal from the reception module 705, for example, a time-varying voltage then goes to a pre-processing module 706 and is converted into a format that can be analyzed by the agent in module 707. Examples of pre-processing modules 706 are an analog to digital converter, image recognition software, or speech recognition software. An analysis module 707 then translate the information into a result that is meaningful to the agent in relation to its status, its mission or both, including options on how to react to the information 701. For example, if the agent is a constellations of telecommunication modules that receives a request for more data bandwidth around a specific ground region, the analysis module can evaluate the requirement and determine if the infrastructure has the capability to fulfill the request, and if the answer is yes, the various options for responding to the request such as moving module transponders to different orbits, assigning more power and propulsion modules in support to a module antenna cluster, etc. are considered.

The results from the analysis module 707 are sent to the Decision module 708 and it decides on the best course of actions for the agent. The decision generated by module 708 is sent to a post-processing module 709 for conversion into a format understandable by the agent's output module. Examples of post-processing modules 709 are a language compiler for a mechanical controller or a speech synthesis module. Output modules may be information transmission modules 710; or an RF antenna, instrument module 711, a robotic arm or a propulsion module. In the above example of a communication constellation, module 708 may decide (i) to use a propulsion module to move several payload modules including transponders and antennas to new orbits that will optimize the coverage area over the region specified by the operator, and (ii) to assign or reassign and organize the communication links between the payload modules, the various relays in space and on the ground and the operator.

A description of this exemplary process including examples is given below in table 1.

The system architecture described above can be used as an elementary building block of the global management system of the space infrastructure. Agents can be organized in groups that are characterized by functions, resources, and like capabilities. Each group can have its own meta-agent architecture. For example, one agent can be entirely hosted by a module, with a payload consisting of a transponder and an antenna for relaying communication of data and systems for managing the internal electronics of the module. Compatible modules may be grouped in a cluster orbiting in close formation. To optimize the assembly, a cluster management logic hosted by the management system 702 configures the cluster's module elements, orientation, transmission power and other operational parameters and composition for the selected mission. The resulting configuration may have multiple capabilities and roles. For example it may process signals among modules in accordance with rules in the logic to achieve best performance. In this capacity it may act as a phase array antenna. Or it may be configured to act as a virtual aperture.

The following describes exemplary space architecture and how the management system is used to optimize performance. Modules, such as described in previous sections including without limitation payloads, propulsion modules, resource processing stations, orbit transfer modules, etc. are organized in a star-type satellite constellation in Low Earth Orbit (LEO) as schematically represented in FIG. 8. The constellation is used for remote sensing and telecommunications. At various positions within the constellation, groups of modules are stored and ready for use. Each module carries a specialized type of payload, for example, a sensor for ground observation comprised of visible, IR, radar or a communication transponder for relaying transmission of information. When not in use, the modules are gathered and packed in storage orbits, for example as shown in FIG. 8.

An example of a mission specific module configuration and use is a scientific mission in the Arctic region collecting and analyzing data on the climate and the fauna. The mission is conducted in coordination with other scientific projects around the globe and requires real-time, high-speed data transmission. Moreover, the scientists in the Arctic are required to changed location often. The mission management team can rent telecommunications capacity from the constellation's operator. On request, selected module groups are unpacked from orbital storage and moved to operational orbits where they are deployed in synthetic aperture cluster configurations. Observation modules and scientists on the ground collect data that is transmitted via the transponder modules.

The constellation management system evaluates and optimizes in real-time the best configurations for the modules clusters including orbital elements, orientation of the synthetic aperture and the best use of the space infrastructure's resources such as number of modules to be used, type of payload, data transmission power, refueling strategies and like characteristics and capabilities.

For example, other missions that may take advantage of the optimized performance of the space infrastructure include information transmission in disaster area, where other communication infrastructures are inoperative or absent, or high-quality, low-cost in-flight entertainment and communication in passenger airplanes.

FIG. 9 is a schematic of the earth and orbit communication network using cloud 114 communications to process payload modules 102 command and control signals. Modules 102 may be stored in orbit and commanded to perform a function in response to signals from an Earth communication system 110 or a mobile Earth communications system 902. Communication may be both ways between and among the various modules and communications systems. Also shown for illustrative purposes is a configured service vehicle module 104 mated to a fuel container 606 standing to move fuel to modules as commanded. Another exemplary module configuration is the orbit transfer module 608 mated with a service vehicle module 104 and fuel module 606 to acquire one or more payloads 102 to move into orbit or mate with other modules as commanded by grounds stations 110 and 902.

Referring to FIG. 10 is an exemplary diagram of the logic for a fuel processing station in low Earth orbit senses an approaching vehicle. FIG. 10 and Table 1 below describe several possible sequences of events, depending on the intentions of the approaching vehicle and other parameters. During these scenarios, the station may have to deal with issues of communications, identify the vehicle, establish two-way transmission link with the proper protocol, collision avoidance, resource management considering available fuel in the station and vehicle requirement, information security, protection of the vehicle depending on the vehicle's origin and intention, internal command and control of the station's propulsion modules, fuel processing modules and other parameters reporting to the ground control center and other issues. Most likely, the agents, operators and devices understand different languages and follow different communications protocols. For example, the operators use natural language as opposed to machine language. In another example, the sensors and instruments in the various modules of a constellation may use different processing and command and control languages.

FIG. 10 is a schema for processing information received by an agent for space module communication, optimization and control previously shown in FIG. 7 and is referenced in Table 1 below and cross-referenced to steps in FIG. 10. A description of this exemplary process, including examples is given in Table 1 below.

TABLE 1

| Steps | Elements | Examples of Rules |
|---|---|---|
| 1001 | Initial state parameters of the agent may be | Fuel processing station in Low Earth Orbit |
| | recorded in Database 703. Information is | detects approaching vehicle and incoming |
| | received by reception module 705. | transmission. Station approach control |
| | Information may come from within the | subsystems are automatically switched from |
| | agent and from outside the agent. | standby to active. |
| 1002 | Pre-processing module 706 and analysis | YES: approach is not part of the station schedule. |
| | module 707 may determine if an action is | NO: approach and transmission are part of a |
| | required, i.e. whether information 1001 is a | scheduled refueling maneuver and all parameters |
| | data or a request. | are nominal. |
| 1003 | Pre-processing module 706 and analysis | YES: transmission contains request for docking |
| | module 707 may determine if the request | following standard procedures. |
| | 1001 is clear. | NO: transmission does not contain a statement of |
| | | intention nor reason for its' unscheduled |
| | | approach. |
| 1004 | Decision module 708 may generate an | Station sends to vehicle request for statement of |
| | appropriate request for clarifying | intentions. |
| | information 1001. Request for clarification | |
| | is sent through post-processing module 709 | |
| | and transmission module 710. | |
| 1005 | The meaning of “safe” may be recorded in | YES: station and vehicle are not in a collision |
| | database 703 and determined by pre- | course. |
| | processing module 706 and analysis | NO: station and vehicle are in a collision course. |
| | module 707. | |
| 1006 | Pre-processing module 706 and analysis | YES: vehicle has communicated maneuver |
| | module 707 may determine if the requester | simulations and safety procedures to station. |
| | is aware of the safety issues. Unclear | NO: vehicle has sent only basic request for |
| | results are treated as NO. | docking and no other information. |
| 1007 | Decision module 708 generates | Station communicates to vehicle analysis results |
| | information to requester about safety | that predict high probability of collision. Station |
| | issues. Information is sent through post- | requests from vehicle information regarding |
| | processing module 709 and transmission | maneuver and safety procedures. |
| | module 710. Request 1001 is put on hold | |
| | until further notice. | |
| 1008 | Analysis module 707 determines if request | YES: all docking ports on station are already |
| | 1001 is in conflict with other information | taken. |
| | (external or internal to the agent). | NO: docking ports available on station. |
| 1009 | Request 1001 is accepted. Decision module | Station sends acceptance of request to vehicle |
| | 708 determines the best course of actions | and confirms approach and docking procedures. |
| | and may send commands and information | |
| | to post-processing module 709. | |
| 1010 | Analysis module 707 determines if agent | YES: one of the vehicles docked at the station is |
| | alone can solve conflict from 1008. | departing soon and the approaching vehicle's |
| | | flight plan can accommodate the wait. |
| | | NO: all vehicles have high-priority missions |
| | | under different chains of command. |
| 1011 | Decision module 708 generates request for | Ground command center for station is informed |
| | outside help in solving conflict from 1008. | of docking port congestion and asked for |
| | Request is sent through post-processing | instructions. |
| | module 709 and transmission module 710. | |
| | Request 1001 is put on hold until further | |
| | notice. | |
| 1012 | Analysis module 707 and decision module | Station generates simulations of holding pattern |
| | 708 solve conflict from 1008. | for approaching vehicle. |
| 1013 | Same as 1009. | Station informs approaching vehicle of docking |
| | | port congestion and schedule. Station sends to |
| | | vehicle instructions for holding pattern. |
| 1014 | Analysis module 707 and decision module | Station logs relative to the vehicle (identification, |
| | 708 determine if, and what parts of, the | approach parameters, communications, etc.) are |
| | event must be recorded to database 703 and | sent to ground control center. |
| | communicated though post-processing | |
| | module 709 and transmission module 710. | |
| 1015 | Final state parameters of the agent may be | Station approach control subsystems are |
| | recorded in Database 703. | switched to standby mode. |

Referring to table 1 above and FIG. 10, the exemplary steps in data process flow information, referred to as data, is received 1001 and referred to a decision node 1002 at which point a binary decision is made. As a matter of principal, when a node is denoted as binary it is an example not a limitation. The node may have more than two decisions options such as a what-if-analysis. If the data receives a “yes” it moves to node 1003 if “no” it moves to node 1004 to request clarification. Node 1003 determines if the data is clear and if yes it continues on the yes path and moves to node 1005 that performs a safety check. At node 1005 a determination that the data has a safety issue it is referred to node 1006 where the requester originating the data is informed that there is a safety issue 1007. If data from nodes 1005 and 1006 may have a conflict on whether the data is safe the conflict is resolved at node 1008. An alternative decision to act on the conflicted data may occur at node 1009. A decision on whether the conflicted data can be resolved internally is made at node 1010 and if not a message is generated requesting external help at node 1011. A determination at node 1010 that the data can be resolved internally is made at node 1012 and the corrective action is taken at node 1013. The approved data is moved to node 1014 and cleared for use by the system at node 1015.

The space infrastructure system may use available programming languages and protocols to implement the various management systems and instruments such as sensors, communication instruments, mechanical or chemical hardware, etc. The Common Space Infrastructure Language (CSIL) is a framework for exchange of information using communications protocols, control and command of dynamic hardware and robotics language to provide an interface with human operators. Natural language processing may be used with the human interface. One objective of the CSIL is to give the space infrastructure the best communication tools for dealing autonomously and efficiently with a great number of agents evolving in an environment that can be highly dynamic, complex and hazardous.

Referring to FIG. 11, in order to handle all these issues in an efficient and timely manner, the CSIL is organized around a common language core that consists of three main modules. The Language Kernel 1101 similar to a computer operating system kernel is compiled for the agent's specific hardware and contains the concepts, vocabulary, syntax, grammar and logic, of the CSIL. A Knowledge and Rules module 1102 attached to the language kernel 1101 contains an extended database for use by an agent, including without limitation identification of the various assembled modules and other useful identification parameters, mission objectives and rules, a list of tools, instruments and methods and management and control available to the agent to fulfill its mission. A Scheduler module 1103 is also attached to the Language Kernel 1101 to set up task priorities and manage interactions with other language modules in real time. Language interpreter may be interfaced with the language core in Kernel 1101 to translate the command and control languages of other agents such as external sensors 1104, including without limitation assembly language, C++, robotics modules, JavaScript, Python, communication networks, IPv6, operators, English into the CSIL. A communications protocol 1106 recognizes the language of a signal and its destination to a module function and converts the signal into a compatible language of the receiving module. An example is robotics language 1107 that drives a physical action. A command signal may be in a different language and must be converted to be actionable by the robot. In effect the communications protocol is a schema comprising command sets that may be activated by a library of commands and converted to a library of actions. The libraries may be based on common commands, icons and language created for the actions and commands. In effect, the protocol may create its own lexicography based on language sets or from acquired knowledge. And a signal feedback loop uses the same methodology. All the modules described above may be modified to adapt to new situations or for upgrades.

It will be obvious to those having skill in the art that many changes may be made to the details of the above-described examples without departing from the underlying principles of the matter described herein. The scope of the claimed subject matter should, therefore, be determined only by the following claims.

We claim:

1. A spacecraft system comprising:
at least two orbiting modules;
module assembly rules;
module command and control systems;
command and control signals; and
applying command and control signals to a module command and control system using module assembly rules to assemble at least two modules into a vehicle.

2. The spacecraft system of claim 1 further comprising module status rules.

3. The spacecraft system of claim 1 further comprising mission requirement rules.

4. The spacecraft system of claim 1 further comprising module status and missions requirement rules.

5. The spacecraft system of claim 1 further comprising a module communication protocol.

6. The spacecraft system of claim 1 further comprising constellation management data and logic.

7. The spacecraft system of claim 1 further comprising translating module status information.

8. The spacecraft system of claim 1 further comprising cluster management logic.

9. A spacecraft assembled from selected orbiting modules comprising;
a propulsion module;
at least one fuel module;
at least one communication module;
at least one mission module;
the propulsion module configured for being removably mated to the fuel module, the communication and the mission module, the propulsion module providing propulsion for moving the fuel module, the communication module and/or the mission module if mated thereto, the propulsion module adapted to move the fuel module, the communications module or the mission module orbit to orbit, and the propulsion module moving the fuel module, the communication module and the mission module into a removeably mated configuration to form the spacecraft.

10. The spacecraft of claim 9 further comprising a logic.

11. The spacecraft of claim 9 further comprising mission requirement logic.

12. The spacecraft of claim 9 further comprising status and missions requirement logic.

13. The spacecraft of claim 9 further comprising a communication protocol.

14. The spacecraft of claim 9 further comprising command and control language.

15. A spacecraft module management system comprising:
accessing orbiting module command and control systems;
adopting configuration rules for at least one module;
instructing a module to activate its' command and control system to configure the module; and
applying the rules to configure a module in response to the command and control system.

16. A communication protocol for an orbiting space module's management and control system comprising:
a lexicography of the module's data structures and system commands;
a selection of module commands to interface with external agent communications;
a communication format to convert the agent communication to the module's lexicography; and
an interpreter of agent originated communication into the module's lexicography.

17. A module communication network, comprising:
common language protocols associated with at least one module;
data storage in a first module;
data formatted in the first module into a common language;
a data transmission device in the first module;
a data reception device in a second module; and
a signal composed of formatted data in the first module sent to the data reception device in the second module.

18. A method of assembling a space vehicle from modules in orbit comprising:
creating modules with selected space vehicle capabilities;
placing one or more modules in orbit; and
assembling modules in orbit into a vehicle.

19. The method of assembling a space vehicle of claim 18 further comprising communicating mission requirements to a module constellation manager.

20. The method of assembling a space vehicle of claim 18 further comprising determining status of a module.

21. The method of assembling a space vehicle of claim 18 further comprising matching mission requirement with module status to select one or more modules for assembly into a space vehicle.

22. The method of assembling a space vehicle of claim 18 further comprising creating a lexicography of module commands.

23. A command and control communications network for processing signals for a space vehicle assembled in orbit comprising:
one or more modules each with at least one command and control signal receptor;
a lexicography of module command and control actions;
a transmitted module command and control signal received by a signal receptor; and
the signal referred to the lexicography and converted into a module command.

24. The command and control apparatus of claim 23 further comprising cloud based module signal processing.

25. The command and control apparatus of claim 23 further comprising a protocol to convert a signal into a language used by a module.

26. A spacecraft comprising:
a payload launched into a first orbit, the payload containing one or more resources;
a service vehicle module adapted to provide transportation to the payload, the service vehicle configured to removably mate with the payload and transport the payload to a second orbit;
a propulsion service module launched in the second orbit, the service vehicle and payload configured to removably mate with the propulsion service.

27. The spacecraft of claim 26, the service vehicle adapted to provide supplies to the payload.

28. The spacecraft of claim 26, the service vehicle adapted to provide electric power to the payload.

29. The spacecraft of claim 26, the service vehicle adapted to provide transportation between the payload and the propulsion service module.

30. The spacecraft of claim 26, the service vehicle adapted to provide transportation between the first and second orbits.

31. The spacecraft of claim 26, further comprising a refinery module in the second orbit adapted to accept one or more raw materials for processing into fuel and other materials to replenish the payload, the service module or the propulsion service module; the refinery module configured to removably mate with the service module to refuel the spacecraft.

32. The spacecraft of claim 26, further comprising a resources processing facility comprising at least one resources processing device, one resources delivery interface, one environmental control device and one process control device.

33. The spacecraft of claim 26, the payload module comprising scientific instruments, telecommunication antennas and transponders, consumables storage, fuel tanks, human habitats, or combinations thereof.

34. The spacecraft of claim 26, the service vehicle module adapted to detach from the payload during the mission.

35. The spacecraft of claim 26, the service vehicle module further comprising a locomotion subsystem.

36. The spacecraft of claim 26, further comprising a second service vehicle module configured to removably mate with the propulsion service module and the payload, the second service vehicle adapted to provide locomotion to the spacecraft.

37. The spacecraft of claim 26, further comprising a second service vehicle module configured to removably mate with the propulsion service module and the payload, the second service vehicle adapted to provide fuel to the spacecraft.

38. A method of assembling a spacecraft in outer space comprising:
launching a payload into a first orbit, the payload containing one or more resources;
launching a service vehicle module into a first orbit, the service module adapted to provide transportation to the payload,
removably mating the service vehicle with the payload;
transporting, by the service vehicle, the payload to a second orbit;
launching a propulsion service module in the second orbit; and
removably mating the service vehicle and payload with the propulsion service to form the spacecraft.

39. A method of claim 38, further comprising:
launching a second service vehicle module into the second orbit;
removably mating the second service vehicle module with the propulsion service module and the payload.

40. A method of claim 39, further comprising:
providing fuel to the spacecraft, by the second service vehicle.

41. A method of claim 38, further comprising:
providing transportation to the spacecraft, by the service vehicle, between the first and second orbits.

42. A method of claim 38, further comprising:
launching a refinery module in the second orbit, the refinery module adapted to store raw materials, and turn raw materials into refined materials;
removably mating the service vehicle to the refinery module to refuel the spacecraft.

43. A spacecraft comprising:
an orbit transfer module;
a service module removably mated to the orbit transfer module for transporting the service module orbit to orbit;
one or more containers adapted for storing unrefined resources configured to be removably mated to the orbit transfer vehicle;
one or more fuel containers adapted for storing process resources c;
the one or more fuel containers configured for removably mating to a processing facility;
the orbit transfer vehicle configured for removably mating to the fuel containers for transferring the fuel containers to a different orbit.

44. The spacecraft of claim 43, the orbit transfer vehicle having one or more high trust rockets for propulsion orbit to orbit.

45. The spacecraft of claim 43, the orbit transfer vehicle having one or more high specific impulse rockets for propulsion orbit to orbit.

46. A method of transporting a payload module orbit-to-orbit comprising:
removably mating an orbit transfer vehicle to a payload module;
transporting the first payload module from a first orbit to a second orbit by the orbit transfer vehicle;
unmating the first payload module from the orbit transfer vehicle;
mating the first payload module to a first service vehicle module,
providing power, by the first service module, to the first payload module;
maintaining the orbit of the first payload module, by the first service module, by high specific impulse propulsion;
mating and transporting the first payload module and first service vehicle to the second orbit, by the orbit transfer vehicle, after power of the first service vehicle is depleted;
removably mating the first service vehicle to a resource processing center adapted to replenish the power of first service vehicle.

47. A method of claim 46 further comprising:
transporting the orbit vehicle back to the first orbit;
removably mating an orbit transfer vehicle to a second payload module in the first orbit;
transporting the second payload module from the first orbit to the second orbit by the orbit transfer vehicle;
unmating the second payload module from the orbit transfer vehicle; and
mating the second payload module to a second service vehicle module.

48. A system for processing information received by an agent spacecraft module for communication, optimization and control, comprising;
one or more agent spacecraft module adapted to receive external or internal information, process the external or internal information and act upon it;
a management system comprising a database module that receives, stores and delivers information to the agent;
the agent is adapted to communicate with the database module in a receptive mode where the agent retrieves data from the database, the agent is adapted to communicate with the database module in an active mode where the agent modifies the database, the receptive mode and the active mode are configured to operate concurrently;
a rules and logic module that assists the agent in evaluating and optimizing the various options for responding to requests received by the management system, comprising:
a reception module adapted for receiving information for the agent;
a pre-processing module adapted for receiving an output signal from the reception module, the pre-processing module adapted to convert the information into a format that can be analyzed by the agent;
an analysis module adapted to translate the information from the pre-processing module into a result that is meaningful to the agent, for the agent to react to the information;
a decision module adapted to receive results from the analysis module and decide how to act or respond to the information, generating decision results; and
a post-processing agent adapted to receive the decision results from the decision module and converts the decision results into a format understandable by an output module of the agent.

49. The system of claim 48, further comprising:
a global management system having groups of agents, the agents organized by groups that are characterized by functions, resources, and like capabilities, each group having its own meta-agent architecture, each group configured in a cluster orbiting in close formation; and
a cluster management system adapted for managing clusters of like modules of the grouped agents, the cluster management logic hosted by the management system configures the group's module elements, orientation, transmission power and other operational parameters and composition for a selected mission to create a resulting configuration.

50. The system of claim 49, the resulting configuration processes signals among modules in accordance with rules in the logic to act as a phase array antenna or a virtual aperture.

51. The system of claim 49, the cluster management system comprising a constellation management system, the constellation management system evaluates and optimizes in real-time configurations for the agent clusters including orbital elements, orientation of the synthetic aperture and use of the system's resources including number of modules to be used, type of payload, data transmission power or refueling strategies.

52. The system of claim 47, the management system receives, stores and delivers information comprising measurements from sensors, user-defined mission rules, or orbital parameters.

53. The system of claim 47, the management system is internal to the agent.

54. The system of claim 47, the management system is external to the agent.

55. The system of claim 47, the reception module comprising optical, radar, thermal or mechanical sensor, or a communication antenna.

56. The system of claim 47, the preprocessing module comprising an analog to digital converter, an image recognition software, or speech recognition software.

57. The system of claim 47, the post-processing modules comprising a language compiler for a mechanical controller or a speech synthesis module.

58. The system of claim 47, the output modules comprising one or more information transmission modules, an RF antenna, an instrument module, a robotic arm or a propulsion module.

59. The system of claim 47,
the agent comprising a constellation of telecommunication modules;
the reception module receives a request for more data bandwidth around a specific ground region;
the analysis module evaluates the request and determines if the infrastructure has the capability to fulfill the request, if there is sufficient bandwidth; and
the decision module evaluates various options for responding to the request comprising moving module transponders to different orbits, or assigning more power and/or propulsion modules in support to a module antenna cluster;
the decision module decides to use a propulsion module to move several payload modules including transponders and antennas to new orbits that will optimize the coverage area over the region specified by the operator, and the decision module decides to assign or reassign and organize the communication links between the payload modules, the various relays in space and on the ground and the operator.
